(19) United States
(12) Patent Application Publication
(10) Pub. No.: US 2008/0035725 A1
(43) Pub. Date: Feb. 14, 2008

(54) METHOD TO USE CELL PHONE LOCATION TO AUTHENTICATE OR ENABLE/DISABLE AUTHORIZATION OF CREDIT CARDS

(75) Inventors: Sivakumar Jambunathan, Round Rock, TX (US); Indran Naick, Cedar Park, TX (US); Cheranellore Vasudevan, Austin, TX (US)

Correspondence Address: CANTOR COLBURN LLP - IBM AUSTIN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/463,902

(22) Filed: Aug. 11, 2006

(51) Int. Cl. G06K 5/00; G06Q 40/00

(52) U.S. Cl. 235/380; 705/44

(57) ABSTRACT

A method for reducing fraudulent usage of credit cards/debit cards, the method comprising: allowing a user owning the credit cards/debit cards to register the credit cards/debit cards to a GPS (Global Positioning System) enabled device, the GPS enabled device connected to a network; allowing the user to define a range at which the credit cards/debit cards are out of range with respect to the GPS enabled device; authorizing use of the credit cards/debit cards owned by the user after it is determined that the credit cards/debit cards and the GPS enabled device are within the user defined range; and denying the authorization of the credit cards/debit cards owned by the user after it is determined that the credit cards/debit cards and the GPS enabled device are outside the user defined range.

### TRADEMARKS

IBM (R is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a method for credit card/debit card authentication/approval of transaction, and particularly to a method for reducing fraudulent usage of credit cards/debit cards by linking a GPS (Global Positioning System) enabled device to the credit cards/debit cards.

2. Description of Background

Credit card fraud occurs in two main ways. The first scenario is when the credit card number is stolen and is used for on-line transactions. Disabling the credit card for on-line transactions can prevent this scenario. The second scenario is where the credit card is physically stolen and the unauthorized person is using the credit card by physically presenting it and/or swiping it at different credit card readers. Known solutions for preventing this scenario include authorizing the use of a cell phone when a credit/debit card purchase is made. Another solution involves using the cell phone itself as a credit card and also using an RFID (Radio Frequency Identification) chip attached to the credit card. However, the above solutions are intrusive in that they require the cell phone to be changed and cannot easily be applied to a plurality of credit cards/debit cards.

Considering the limitations of the aforementioned methods, it is clear that there is a need for a method for reducing fraudulent usage of a credit card/debit card. In the proposed method fraudulent usage of credit cards/debit cards is reduced by linking the authentication of the owner of the credit cards/debit cards to the physical proximity of the owner's cell phone measured electronically

### SUMMARY OF THE INVENTION

The shortcomings of the prior art are overcome and additional advantages are provided through the provision of a method for reducing fraudulent usage of credit cards/debit cards, the method comprising: allowing a user owning the credit cards/debit cards to register the credit cards/debit cards to a GPS (Global Positioning System) enabled device, the GPS enabled device connected to a network; allowing the user to define a range at which the credit cards/debit cards are out of range with respect to the GPS enabled device; authorizing use of the credit cards/debit cards owned by the user after it is determined that the credit cards/debit cards and the GPS enabled device are within the user defined range; and denying the authorization of the credit cards/debit cards owned by the user after it is determined that the credit cards/debit cards and the GPS enabled device are outside the user defined range.

The shortcomings of the prior art are overcome and additional advantages are provided through the provision of a system for reducing fraudulent usage of credit cards/debit cards, the system comprising: a network; and a host system in communication with the network, the host system including software to implement a method comprising: allowing a user owning the credit cards/debit cards to register the credit cards/debit cards to a GPS (Global Positioning System) enabled device, the GPS enabled device connected to a network; allowing the user to define a range at which the credit cards/debit cards are out of range with respect to the GPS enabled device; authorizing use of the credit cards/debit cards owned by the user after it is determined that the credit cards/debit cards and the GPS enabled device are within the user defined range; and denying the authorization of the credit cards/debit cards owned by the user after it is determined that the credit cards/debit cards and the GPS enabled device are outside the user defined range.

The shortcomings of the prior art are overcome and additional advantages are provided through the provision of a computer program product for reducing fraudulent usage of credit cards/debit cards, the computer program product comprising: a storage medium readable by a processing circuit and storing instructions for execution by the processing circuit for performing a method comprising: allowing a user owning the credit cards/debit cards to register the credit cards/debit cards to a GPS (Global Positioning System) enabled device, the GPS enabled device connected to a network; allowing the user to define a range at which the credit cards/debit cards are out of range with respect to the GPS enabled device; authorizing use of the credit cards/debit cards owned by the user after it is determined that the credit cards/debit cards and the GPS enabled device are within the user defined range; and denying the authorization of the credit cards/debit cards owned by the user after it is determined that the credit cards/debit cards and the GPS enabled device are outside the user defined range.

Additional features and advantages are realized through the techniques of the present invention. Other embodiments and aspects of the invention are described in detail herein and are considered a part of the claimed invention. For a better understanding of the invention with advantages and features, refer to the description and the drawings.

### Technical Effects

As a result of the summarized invention, technically we have achieved a solution that provides for a method for reducing fraudulent usage of credit cards/debit cards by linking a GPS enabled device to the credit cards/debit cards.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of system for reducing fraudulent usage of credit cards/debit cards according to the exemplary embodiments of the present invention; and

FIG. 2 illustrates one example of a flowchart illustrating a method for reducing fraudulent usage of credit cards/debit cards according to the exemplary embodiments of the present invention.

### DETAILED DESCRIPTION OF THE INVENTION

One aspect of the exemplary embodiments is a method for linking a GPS (Global Positioning System) cell phone to credit cards/debit cards (CC/DC) to limit fraudulent use outside the range of the cell phone. Another aspect of the exemplary embodiments is a method for providing for user registration of CC/DC with a cell phone so that use of the CC/DC causes the checking of the GPS phone within a registered range predefined by the owner of the CC/DC.

The exemplary embodiments aim to reduce fraudulent usage of credit cards/debit cards by linking the authentication to the physical proximity of the owner's cell phone detected electronically. By detecting the distance between the credit card land cell phone, the authentication mechanism can validate whether the use of the CC/DC is authorized or not.

One object of the exemplary embodiments is to link a GPS cell phone to credit cards/debit cards to facilitate additional location information. The exemplary embodiments of the present invention prevent fraudulent usage of credit cards/debit cards outside the range of the GPS cell phone. The exemplary embodiments assist cardholders to ensure that their cards are used within the range of their phones as well as helping credit card companies reduce and/or prevent fraud. This is especially useful for individuals who travel frequently as it is usually their transactions that have the highest risk. In the event that credit cards/debit cards are lost, the user can turn off their cell phone, which makes it difficult for any one to use the credit cards/debit cards. Then the user can call each of the individual card companies and notify of the card loss.

The exemplary embodiments of the present invention operate as follows: (1) Credit/debit cards are registered by users to their GPS enabled cell phone, (2) The user has the ability to define the distance to which the credit card/debit card and cell phone can be out of range, (3) When the user attempts a purchase by using the credit card/debit card, a check is performed by the credit card/debit card authorizing company to determine if the GPS cell phone is within the defined range, (4) If the presence of the cell phone is out of range of the region from where the credit card/debit card is being used, the credit card/debit card transaction is not allowed, and (5) If the presence of the cell phone is within the range of the region from where the credit card/debit card is being used, the credit card/debit card transaction is allowed and the transaction continues as usual. The above process is used only for “cardholder present” transactions. If both cell phone and credit card are stolen together, it is possible for the person who stole those to use the credit card, however, since the cell phone is then ON, it may be easier to detect the location where the unauthorized person is using the credit card/debit card and notify the authorities.

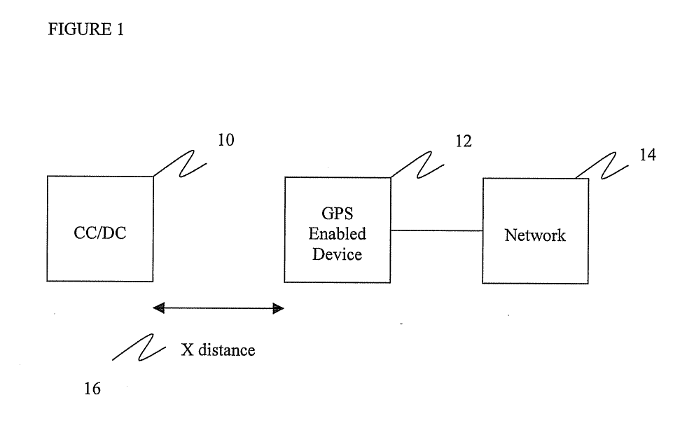

Referring to FIG. 1, one example of system for reducing fraudulent usage of credit cards/debit cards according to the exemplary embodiments of the present invention is illustrated. The system of FIG. 1 depicts a credit card/debit card 10, which is at a distance 16 (X) from a GPS enabled device 12. The GPS enabled device 12 is connected to a network 14. When a user uses the credit card/debit card 10, it is determined whether the distance 16 (X) between the credit card/debit card 10 and the GPS enabled device 12 is within an acceptable range defined beforehand by the owner of the credit card/debit card 10.

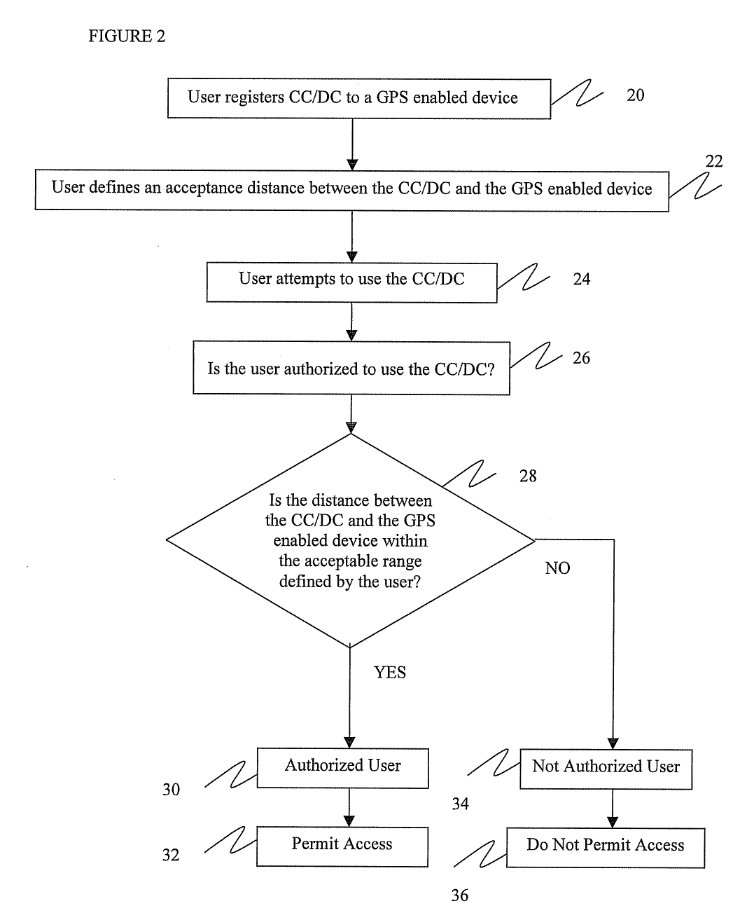

Referring to FIG. 2, one example of a flowchart illustrating a method for reducing fraudulent usage of credit cards/debit cards according to the exemplary embodiments of the present invention is illustrated. In step 20, the user registers the CC/DC to a GPS enabled device. In step 22, the user defines an acceptable range between the CC/DC and the GPS enabled device. In step 24, a user attempts to use the CC/DC. In step 26, the system asks whether the user is authorized to use the CC/DC. In step 28, the distance between the CC/DC and the GPS enabled device is computed and it is determined whether the distance is within an acceptable range predefined by the owner of the CC/DC. If the distance is within the acceptable predefined range, the process flows to step 30 where the user is deemed as an authorized user. In step 32, the user is permitted to utilize the CC/DC for purchases. If the distance is not within the acceptable predefined range, the process flows to step 34 where the user is deemed as a non-authorized user. In step 36, the user is not permitted to utilize the CC/DC for purchases.

Therefore, the exemplary embodiments of the present invention provide for an efficient means of reducing or preventing fraudulent usage of credit cards/debit cards by linking a GPS enabled device, such as a cell phone, to the credit cards/debit cards by allowing a user owning the credit cards/debit cards to define a physical distance separating the GPS enabled device and the credit cards/debit cards in use for proper authorization.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for reducing fraudulent usage of credit cards/debit cards, the method comprising:
allowing a user owning the credit cards/debit cards to register the credit cards/debit cards to a GPS (Global Positioning System) enabled device, the GPS enabled device connected to a network;
allowing the user to define a range at which the credit cards/debit cards are out of range with respect to the GPS enabled device;
authorizing use of the credit cards/debit cards owned by the user after it is determined that the credit cards/debit cards and the GPS enabled device are within the user defined range; and
denying the authorization of the credit cards/debit cards owned by the user after it is determined that the credit cards/debit cards and the GPS enabled device are outside the user defined range.

2. The method of claim 1, wherein the GPS enabled device is a cell phone.

3. The method of claim 1, wherein the network is a cell phone network.

4. A system for reducing fraudulent usage of credit cards/debit cards, the system comprising:
a network; and
a host system in communication with the network, the host system including software to implement a method comprising:
allowing a user owning the credit cards/debit cards to register the credit cards/debit cards to a GPS (Global Positioning System) enabled device, the GPS enabled device connected to the network;
allowing the user to define a range at which the credit cards/debit cards are out of range with respect to the GPS enabled device;
authorizing use of the credit cards/debit cards owned by the user after it is determined that the credit cards/debit cards and the GPS enabled device are within the user defined range; and
denying the authorization of the credit cards/debit cards owned by the user after it is determined that the credit cards/debit cards and the GPS enabled device are outside the user defined range.

5. The system of claim 4, wherein the GPS enabled device is a cell phone.

6. The system of claim 4, wherein the network is a cell phone network.

7. A computer program product for reducing fraudulent usage of credit cards/debit cards, the computer program product comprising:
a storage medium readable by a processing circuit and storing instructions for execution by the processing circuit for performing a method comprising:
allowing a user owning the credit cards/debit cards to register the credit cards/debit cards to a GPS (Global Positioning System) enabled device, the GPS enabled device connected to a network;
allowing the user to define a range at which the credit cards/debit cards are out of range with respect to the GPS enabled device;
authorizing use of the credit cards/debit cards owned by the user after it is determined that the credit cards/debit cards and the GPS enabled device are within the user defined range; and
denying the authorization of the credit cards/debit cards owned by the user after it is determined that the credit cards/debit cards and the GPS enabled device are outside the user defined range.

8. The computer program product of claim 7, wherein the GPS enabled device is a cell phone.

9. The computer program product of claim 7, wherein the network is a cell phone network.
